(19) United States
(12) Patent Application Publication
(10) Pub. No.: US 2025/0393005 A1
(43) Pub. Date: Dec. 25, 2025

(54) COMMUNICATION METHOD, TERMINAL DEVICE, AND NETWORK DEVICE

(71) Applicant: Quectel Wireless Solutions Co., Ltd., Shanghai (CN)

(72) Inventors: Ling LYU, Shanghai (CN); Zheng ZHAO, Shanghai (CN); Zhongzhi YANG, Shanghai (CN)

(73) Assignee: Quectel Wireless Solutions Co., Ltd., Shanghai (CN)

(21) Appl. No.: 19/317,378

(22) Filed: Sep. 3, 2025

Related U.S. Application Data
(63) Continuation of application No. PCT/CN2023/082485, filed on Mar. 20, 2023.

(51) Int. Cl. H04W 56/00; H04W 84/06

(52) U.S. Cl. CPC H04W 56/0045; H04W 84/06

(57) ABSTRACT

A communication method includes: a terminal device sending first information to a network device, wherein the first information indicates information of updating timing and frequency pre-compensation within a first time period. The terminal device sends the information of updating timing and frequency pre-compensation to the network device, so that the network device can directly or indirectly know DMRS bundling information of the terminal device, and thus information associated with failures of power consistency and/or phase continuity can be synchronized between the network device and the terminal device, thereby improving the performance of joint channel estimation.

### CROSS-REFERENCE TO RELATED APPLICATIONS

The present application is a continuation of International Application No. PCT/CN2023/082485, filed on Mar. 20, 2023, the disclosure of which is hereby incorporated by reference in its entirety.

### TECHNICAL FIELD

The present disclosure relates to the fields of communication technologies, and more specifically, to a communication method, a terminal device, and a network device.

### BACKGROUND

In a non-terrestrial network (NTN), a network device can implement communication through a non-terrestrial network device (e.g., a communication satellite). Compared to conventional cellular communication, communication provided by a satellite communication system may have a significantly larger cell radius, and transmission delay in satellite communication is also greater.

In NTN, due to changes in transmission delay and Doppler shift caused by relative motion between a satellite and a terminal device, phase required for demodulation reference signal (DMRS) bundling is not continuous and/or power required for bundling changes. Therefore, the terminal device should periodically perform timing and frequency pre-compensation update.

### SUMMARY

The present disclosure provides a communication method, a terminal device, and a network device. Various aspects of the present disclosure are described below.

In a first aspect, a communication method is provided. The method includes: sending, by a terminal device, first information to a network device in an NTN cell, where the first information indicates information of updating timing and frequency pre-compensation within a first time period.

In some embodiments, the information of updating timing and frequency pre-compensation includes one or more compensation segments, which indicate a time period for updating pre-compensation in time domain and/or frequency domain.

In some embodiments, the compensation segment is determined based on one or more of the following: a predefined value; a dynamically changing value; or a first event, where the first event is associated with a failure in power consistency and/or phase continuity.

In some embodiments, the information of updating timing and frequency pre-compensation further includes: one or more compensation segments, which indicate a time period for updating pre-compensation in time domain and/or frequency domain; and a quantity of repetitions corresponding to the compensation segments.

In some embodiments, the information of updating timing and frequency pre-compensation includes a first compensation segment and a first adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment and the first adjustment amount.

In some embodiments, the information of updating timing and frequency pre-compensation includes a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment, the first adjustment amount, and the second adjustment amount.

In some embodiments, the second compensation segment satisfies the following: x₀−x₁*t−x₂*t₂, where x₀ represents the first compensation segment, x₁ represents the first adjustment amount, x₂ represents the second adjustment amount, and t is a time difference between a start instant of a first interval and a corresponding instant of a second interval.

In some embodiments, the first information is determined based on one or more of the following information: ephemeris information corresponding to the network device, parameters configured by the network device, relative motion relationship between the terminal device and the network device, elevation angle of the network device, and location information of the terminal device.

In some embodiments, the first information is used to determine a length of a first DMRS bundling window.

In some embodiments, the first DMRS bundling window belongs to a plurality of DMRS bundling windows, and the first information is used to determine lengths of the plurality of DMRS bundling windows.

In some embodiments, the length of the first DMRS bundling window is determined based on the first information and a nominal time domain window length.

In some embodiments, the first time period includes a current instant and/or a subsequent time period.

In a second aspect, a communication method is provided. The method includes: receiving, by a network device, first information from a terminal device in an NTN cell, where the first information indicates information of updating timing and frequency pre-compensation within a first time period.

In some embodiments, the information of updating timing and frequency pre-compensation includes one or more compensation segments, which indicate a time period for updating pre-compensation in time domain and/or frequency domain.

In some embodiments, the compensation segment is determined based on one or more of the following: a predefined value; a dynamically changing value; or a first event, where the first event is associated with a failure in power consistency and/or phase continuity.

In some embodiments, the information of updating timing and frequency pre-compensation further includes: one or more compensation segments, which indicate a time period for updating pre-compensation in time domain and/or frequency domain; and a quantity of repetitions corresponding to the compensation segments.

In some embodiments, the information of updating timing and frequency pre-compensation includes a first compensation segment and a first adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment and the first adjustment amount.

In some embodiments, the information of updating timing and frequency pre-compensation includes a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment, the first adjustment amount, and the second adjustment amount.

In some embodiments, the second compensation segment satisfies the following: x₀−x₁*t−x₂*t₂, where x₀ represents the first compensation segment, x₁ represents the first adjustment amount, x₂ represents the second adjustment amount, and t is a time difference between a start instant of a first interval and a corresponding instant of a second interval.

In some embodiments, the first information is determined based on one or more of the following information: ephemeris information corresponding to the network device, parameters configured by the network device, relative motion relationship between the terminal device and the network device, elevation angle of the network device, and location information of the terminal device.

In some embodiments, the first information is used to determine a length of a first DMRS bundling window.

In some embodiments, the first DMRS bundling window belongs to a plurality of DMRS bundling windows, and the first information is used to determine lengths of the plurality of DMRS bundling windows.

In some embodiments, the length of the first DMRS bundling window is determined based on the first information and a nominal time domain window length.

In some embodiments, the first time period includes a current instant and/or a subsequent time period.

In a third aspect, a terminal device is provided. The terminal device includes: a sending unit, sending first information to a network device in an NTN cell, where the first information indicates information of updating timing and frequency pre-compensation within a first time period.

In some embodiments, the information of updating timing and frequency pre-compensation includes one or more compensation segments, which indicate a time period for updating pre-compensation in time domain and/or frequency domain.

In some embodiments, the compensation segment is determined based on one or more of the following: a predefined value; a dynamically changing value; or a first event, where the first event is associated with a failure in power consistency and/or phase continuity.

In some embodiments, the information of updating timing and frequency pre-compensation further includes: one or more compensation segments, which indicate a time period for updating pre-compensation in time domain and/or frequency domain; and a quantity of repetitions corresponding to the compensation segments.

In some embodiments, the information of updating timing and frequency pre-compensation includes a first compensation segment and a first adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment and the first adjustment amount.

In some embodiments, the information of updating timing and frequency pre-compensation includes a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment, the first adjustment amount, and the second adjustment amount.

In some embodiments, the second compensation segment satisfies the following: x₀−x₁*t−x₂*t₂, where x₀ represents the first compensation segment, x₁ represents the first adjustment amount, x₂ represents the second adjustment amount, and t is a time difference between a start instant of a first interval and a corresponding instant of a second interval.

In some embodiments, the first information is determined based on one or more of the following information: ephemeris information corresponding to the network device, parameters configured by the network device, relative motion relationship between the terminal device and the network device, elevation angle of the network device, and location information of the terminal device.

In some embodiments, the first information is used to determine a length of a first DMRS bundling window.

In some embodiments, the first DMRS bundling window belongs to a plurality of DMRS bundling windows, and the first information is used to determine lengths of the plurality of DMRS bundling windows.

In some embodiments, the length of the first DMRS bundling window is determined based on the first information and a nominal time domain window length.

In some embodiments, the first time period includes a current instant and/or a subsequent time period.

In a fourth aspect, a network device is provided. The network device includes: a receiving unit, receiving first information from a terminal device in an NTN cell, where the first information indicates information of updating timing and frequency pre-compensation within a first time period.

In some embodiments, the information of updating timing and frequency pre-compensation includes one or more compensation segments, which indicate a time period for updating pre-compensation in time domain and/or frequency domain.

In some embodiments, the compensation segment is determined based on one or more of the following: a predefined value; a dynamically changing value; or a first event, where the first event is associated with a failure in power consistency and/or phase continuity.

In some embodiments, the information of updating timing and frequency pre-compensation further includes: one or more compensation segments, which indicate a time period for updating pre-compensation in time domain and/or frequency domain; and a quantity of repetitions corresponding to the compensation segments.

In some embodiments, the information of updating timing and frequency pre-compensation includes a first compensation segment and a first adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment and the first adjustment amount.

In some embodiments, the information of updating timing and frequency pre-compensation includes a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment, the first adjustment amount, and the second adjustment amount.

In some embodiments, the second compensation segment satisfies the following: x₀−x₁*t−x₂*t₂, where x₀ represents the first compensation segment, x₁ represents the first adjustment amount, x₂ represents the second adjustment amount, and t is a time difference between a start instant of a first interval and a corresponding instant of a second interval.

In some embodiments, the first information is determined based on one or more of the following information: ephemeris information corresponding to the network device, parameters configured by the network device, relative motion relationship between the terminal device and the network device, elevation angle of the network device, and location information of the terminal device.

In some embodiments, the first information is used to determine a length of a first DMRS bundling window.

In some embodiments, the first DMRS bundling window belongs to a plurality of DMRS bundling windows, and the first information is used to determine lengths of the plurality of DMRS bundling windows.

In some embodiments, the length of the first DMRS bundling window is determined based on the first information and a nominal time domain window length.

In some embodiments, the first time period includes a current instant and/or a subsequent time period.

In a fifth aspect, a terminal device is provided, including a processor and a memory, where the memory is configured to store one or more computer programs, and the processor is configured to invoke the computer programs in the memory to cause the terminal device to implement some or all of the steps of the method according to the first aspect.

In a sixth aspect, a network device is provided, including a processor, a memory, and a transceiver, where the memory is configured to store one or more computer programs, and the processor is configured to invoke the computer programs in the memory to cause the network device to implement some or all of the steps of the method according to the second aspect.

In a seventh aspect, an embodiment of the present disclosure provides a communication system, including the terminal device and/or the network device described above. In another possible design, the system may further include other devices that interact with the terminal device or the network device according to solutions provided in the embodiments of the present disclosure.

In an eighth aspect, an embodiment of the present disclosure provides a computer-readable storage medium storing a computer program, where the computer program causes a terminal device and/or a network device to implement some or all of the steps of the method according to the aspects described above.

In a ninth aspect, an embodiment of the present disclosure provides a computer program product, including a non-transitory computer-readable storage medium storing a computer program, where the computer program is operable to cause a terminal device and/or a network device to perform some or all of the steps of the method according to the aspects described above. In some implementations, the computer program product may be a software installation package.

In a tenth aspect, an embodiment of the present disclosure provides a chip, including a memory and a processor, where the processor may invoke and run a computer program from the memory to perform some or all of the steps of the method according to the aspects described above.

A terminal device sends information of updating timing and frequency pre-compensation to a network device, so that the network device can directly or indirectly know DMRS bundling information of the terminal device, and thus information associated with a failure in power consistency and/or phase continuity can be synchronized between the network device and the terminal device, thereby improving the performance of joint channel estimation.

### BRIEF DESCRIPTION OF THE DRAWINGS

FIG. 1 is a schematic diagram of a wireless communication system to which an embodiment of the present disclosure is applied.

FIG. 2 is a schematic flowchart of a communication method according to an embodiment of the present disclosure.

FIG. 3 is an exemplary diagram illustrating the effect of satellite motion on round-trip delay according to an embodiment of the present disclosure.

FIG. 4 is an exemplary diagram illustrating the effect of satellite motion on Doppler shift according to an embodiment of the present disclosure.

FIG. 5 is a schematic structural diagram of a terminal device according to an embodiment of the present disclosure.

FIG. 6 is a schematic structural diagram of a network device according to an embodiment of the present disclosure.

FIG. 7 is a schematic structural diagram of an apparatus for communication according to an embodiment of the present disclosure.

### DETAILED DESCRIPTION OF THE EMBODIMENTS

The technical solutions in the present disclosure will be described below with reference to the accompanying drawings.

### Communication System

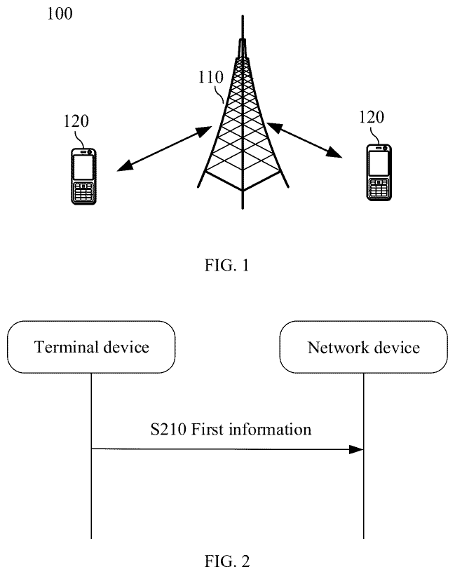

FIG. 1 shows a wireless communication system 100 to which an embodiment of the present disclosure is applied. The wireless communication system 100 may include a network device 110 and a terminal device 120. The network device 110 may be a device that communicates with the terminal device 120. The network device 110 may provide communication coverage in a specific geographic area and may communicate with the terminal device 120 located in the coverage area.

FIG. 1 exemplarily shows one network device and two terminal devices. Optionally, the wireless communication system 100 may include a plurality of network devices and another quantity of terminal devices may be included within coverage area of each network device, which is not limited in embodiments of the present disclosure.

Optionally, the wireless communication system 100 may further include other network entities such as a network controller and a mobility management entity, which is not limited in embodiments of the present disclosure.

It should be understood that the technical solutions of embodiments of the present disclosure can be applied to various communication systems, such as a 5th generation (5G) system or a new radio (NR) system, a long term evolution (LTE) system, an LTE frequency division duplex (FDD) system, an LTE time division duplex (TDD) system, and the like. The technical solutions provided by the present disclosure can also be applied to future communication systems, such as a 6th generation mobile communication system and a satellite communication system.

A terminal device in embodiments of the present disclosure may also be referred to as a user equipment (UE), an access terminal, a subscriber unit, a subscriber station, a mobile site, a mobile station (MS), a mobile terminal (MT), a remote station, a remote terminal, a mobile device, a user terminal, a terminal, a wireless communication device, a user agent, or a user apparatus. The terminal device in embodiments of the present disclosure may be a device that provides a user with voice and/or data connectivity, and may be configured to connect people, objects, and machines, such as a handheld device, a vehicle-mounted device, or the like that has a wireless connection function. The terminal device in embodiments of the present disclosure may be a mobile phone, a tablet computer (Pad), a laptop computer, a handheld computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like. Optionally, the UE may be configured to act as a base station. For example, the UE may act as a scheduling entity that provides sidelink signals between UEs in vehicle-to-everything (V2X), device-to-device (D2D), or the like. For example, a cellular phone and an automobile communicate with each other using sidelink signals. A cellular phone and a smart home device communicate with each other without relaying communication signals through a base station.

A network device in embodiments of the present disclosure may be a device for communicating with the terminal device. The network device may also be referred to as an access network device or a radio access network device. For example, the network device may be a base station. The network device in embodiments of the present disclosure may be a radio access network (RAN) node (or device) that connects the terminal device to a wireless network. The base station may broadly cover various names as follows, or may be interchangeable with one of the following names, such as a Node B (NodeB), an evolved NodeB (eNB), a next generation NodeB (gNB), a relay station, a transmitting and receiving point (TRP), a transmitting point (TP), a master eNB (MeNB), a secondary eNB (SeNB), a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof. The base station may also be a communication module, a modem, or a chip disposed in the device or apparatus described above. The base station may also be a mobile switching center, a device that functions as a base station in D2D, V2X, and machine-to-machine (M2M) communications, a network-side device in a 6G network, a device that functions as a base station in a future communication system, or the like. The base station may support networks with a same access technology or different access technologies. A specific technology and a specific device form used by the network device are not limited in embodiments of the present disclosure.

The base station may be fixed or mobile. For example, a helicopter or an unmanned aerial vehicle may be configured to act as a mobile base station, and one or more cells may move according to a location of the mobile base station. In other examples, a helicopter or an unmanned aerial vehicle may be configured to serve as a device in communication with another base station.

In some deployments, the network device in embodiments of the present disclosure may be a CU or a DU, or the network device includes a CU and a DU. The gNB may further include an AAU.

The network device and terminal device may be deployed on land, including indoors or outdoors, handheld, or vehicle-mounted; may be deployed on water; or may be deployed on airplanes, balloons, or satellites in the air. A scene in which the network device and the terminal device are located is not limited in embodiments of the present disclosure.

It should be understood that all or part of the functionality of the communication device in the present disclosure may also be implemented by software functionality running on hardware or by virtualization functionality instantiated on a platform (e.g., a cloud platform).

### Non-Terrestrial Network (NTN)

In an NTN, the network device 110 may be implemented through a non-terrestrial network device (e.g., a communication satellite), meaning that the NTN may include a satellite communication system. Compared to conventional cellular communication, the satellite communication system can provide a significantly larger cell radius, and the transmission delay in satellite communication is also greater. Due to the orbital movement of satellites, the transmission delay and Doppler shift in NTN can exhibit regular variations.

Communication satellites are categorized based on their orbital altitudes into low-earth orbit (LEO) satellites, medium-earth orbit (MEO) satellites, geostationary earth orbit (GEO) satellites, high elliptical orbit (HEO) satellites, etc. A LEO satellite has an orbital altitude of 500 km to 1500 km and a corresponding orbital period of approximately 1.5 hours to 2 hours. The signal propagation delay for single-hop communication between users is generally less than 20 ms. The maximum satellite visibility time is 20 minutes. The GEO satellite has an orbital altitude of 35,786 km and a rotation period of 24 hours around the earth.

### Joint Channel Estimation

Through the channel estimation process, channel state information can be obtained. Joint channel estimation is a method that combines multiple channels for channel estimation to obtain more accurate channel state information. Applying joint channel estimation can bring coverage enhancement performance gains.

During a repetition transmission process of physical uplink shared channel (PUSCH), a network device may combine DMRSs in multiple slots for channel estimation, i.e., multiple DMRSs may be bundled for channel estimation. In some communication systems (e.g., NR systems), DMRS symbols need to maintain power consistency and phase continuity within a time domain window (TDW) for bundling in order to achieve joint channel estimation. The network device may configure whether a terminal device performs DMRS bundling and a length of the time domain window for bundling (hereinafter referred to as bundling window length). The terminal device may perform DMRS bundling based on the configuration and allow possible events to terminate a current time domain window.

In NTNs, due to changes in transmission delay and Doppler shift caused by the relative motion between a satellite and a terminal device, the DMRS symbols received by a network device will experience a specific phase offset, leading to a case that the phase continuity required for DMRS bundling is not met. Therefore, the terminal device should periodically update pre-compensation in time domain and/or frequency domain (hereinafter referred to as timing and frequency pre-compensation update). Additionally, due to changes in transmission delay and Doppler shift caused by the relative motion between the satellite and the user, the terminal device needs to frequently update the timing advance and Doppler shift pre-compensation. In some specifications, the aforementioned events are considered as events that result in a failure in power consistency and phase continuity. The event may refer to an event that may result in a failure in power consistency or phase continuity. These events include drop/cancel transmission events defined based on Rel-15/16 conflict rules, as well as other factors defined that may result in a failure in power consistency or phase continuity. When these events occur, the terminal device may terminate the current time domain window for DMRS bundling (hereinafter referred to as DMRS bundling window). Therefore, the event may also be referred to as an update event, interrupt event, or end event of the bundling window. After an event occurs, the terminal device may decide whether to start a new DMRS bundling window based on configuration, event type, and its own capabilities. After terminating the time domain window, the terminal device may decide to restart a new time domain window and perform DMRS bundling based on the relative motion relationship between the user and the satellite as well as the capabilities of the user.

Pre-compensation can be achieved through segmented pre-compensation. Segmented pre-compensation has already been applied in some communication systems (e.g., IoT-NTN systems). A network device may configure a segment length for pre-compensation for users. A terminal device may perform pre-compensation update only between segments while maintaining a constant pre-compensation value within a segment. Segmented pre-compensation technology can be applied to removing impacts of delay drift and Doppler shift on long-duration transmission.

The applicant has discovered that the network device may not be aware of timing and frequency pre-compensation update, leading to various problems. For example, the terminal device may autonomously perform a first operation. The first operation may include an operation corresponding to time of interrupting the DMRS bundling window. That is, the first operation may include an operation or an event of timing and frequency pre-compensation update. In such cases, the network device may find it difficult to determine the execution of timing and frequency pre-compensation update. As a result, the terminal device may have interrupted the DMRS bundling window due to timing and frequency pre-compensation update, but the network device has not yet interrupted the DMRS bundling window. This can lead to the bundling windows of the network device and the terminal device out of sync, which results in a performance loss in joint channel estimation, thereby limiting the application of joint channel estimation in communication systems.

FIG. 2 is a schematic flowchart of a communication method according to an embodiment of the present disclosure to address the aforementioned problems. The method shown in FIG. 2 may be performed by a network device and a terminal device. The network device may be a non-terrestrial network device. For example, the network device may be a satellite. The method shown in FIG. 2 may include step S210.

In step S210, the terminal device receives first information. Correspondingly, the network device sends the first information.

The first information may be used to indicate information of updating timing and frequency pre-compensation within a first time period. The information of updating timing and frequency pre-compensation is used to indicate information related to timing and frequency pre-compensation update. The terminal device may perform timing and frequency pre-compensation update to meet the phase continuity required for a DMRS bundling time domain window. As mentioned above, timing and frequency pre-compensation update may be related to joint channel estimation in NTN systems. Therefore, the information of updating timing and frequency pre-compensation may correspond to the transmission process of DMRS bundling.

In some embodiments, the information of updating timing and frequency pre-compensation may include information related to a DMRS bundling window. That is, the information of updating timing and frequency pre-compensation may include information about determining a DMRS bundling window length. For example, the information of updating timing and frequency pre-compensation may include the timing, interval, or time period of the timing and frequency pre-compensation update. After receiving timing and frequency pre-compensation information, the network device may determine DMRS bundling window information based on the information.

In some embodiments, the information of updating timing and frequency pre-compensation may include the DMRS bundling window information determined based on the timing and frequency pre-compensation update. The network device may directly obtain the DMRS bundling window information via the first information. For example, the timing and frequency pre-compensation information may include a length of the DMRS bundling window.

The terminal device sends the first information to the network device, so that the network device can know DMRS bundling information of the terminal device, and thus information of events related to a failure in power consistency and/or phase continuity can be synchronized between the network device and the terminal device, thereby improving the performance of joint channel estimation.

In some embodiments, the first information may be used to determine a length of a first DMRS bundling window. For example, the terminal device may determine the length of the first DMRS bundling window and send the length of the first DMRS bundling window to the network device via the first information. Alternatively, the network device may determine the length of the first DMRS bundling window based on the first information.

It should be noted that the first information may be used not only to determine a length of one DMRS bundling window but also to determine lengths of a plurality of bundling windows. That is, the first information may be used to determine the length of one or more DMRS bundling windows. The one or more DMRS bundling windows may include the first DMRS bundling window described above. The lengths of the plurality of DMRS bundling windows may be the same or different.

As an implementation, the length of the first DMRS bundling window may be determined based on the first information and a configured nominal time domain window length. For example, for each transmission, when a configured nominal time domain window ends, the terminal device may terminate the first DMRS bundling window and determine whether to start a new DMRS bundling according to the specifications.

As an implementation, the length of the first DMRS bundling window may be determined based on a first event. The first event may be related to the failure in power consistency and/or phase continuity. For example, the first event may be an explicitly defined event in relevant specifications. When the first event occurs, the terminal device may terminate the first DMRS bundling window and determine whether to start a new DMRS bundling according to the specifications.

By obtaining the information of updating timing and frequency pre-compensation corresponding to a transmission process of DMRS bundling, the network device may determine a length of a DMRS bundling window during the transmission process of DMRS bundling, which enables the network device to determine when the terminal device performs DMRS bundling and the length of the DMRS bundling window, thereby avoiding the synchronization problem of the DMRS bundling window length between the network device and the terminal device due to excessive phase offset and timing adjustment in NTNs. This allows the network device to correctly perform joint channel estimation and achieve coverage gain.

The first time period may include a current instant and/or a subsequent time period. That is, the first information may be used to indicate current information of updating timing and frequency pre-compensation or future information of updating timing and frequency pre-compensation. The future information of updating timing and frequency pre-compensation may be predicted by the terminal device.

When the first information indicates information of updating timing and frequency pre-compensation at current instant, the first information can quickly reflect changes in the information of updating timing and frequency pre-compensation, which allows the latest information of updating timing and frequency pre-compensation to be sent to the network device in a timely manner in cases where the changes in the information of updating timing and frequency pre-compensation are significant. When the first information indicates future information of updating timing and frequency pre-compensation, the network device can be informed of the timing and frequency pre-compensation in advance even if there is a large delay between the network device and the terminal device, enabling timely adjustments to joint channel estimation.

The method for determining a start instant and an end instant of the first time period is not limited in the present disclosure. In some embodiments, the first time period may include the duration occupied by one continuous transmission. In some embodiments, the start instant of the first time period may be an instant when the first information is sent or received. That is, the first information may be valid from the instant when the first information is sent or received. In some embodiments, the end instant of the first time period may be an instant for the next transmission or reception of the first information. That is, the validity period of the first information may last until the instant for the next transmission or reception of the first information. For example, upon receiving the first information, the network device may start to determine the length of one or more DMRS bundling windows based on the first information until the next reception of the first information. Upon the next reception of the first information, the network device may start to determine the lengths of the plurality of DMRS bundling windows based on the first information of the next reception.

The contents that may be included in the information of updating timing and frequency pre-compensation will be described in detail below with reference to embodiments. Additionally, how to determine the DMRS bundling window length based on the information of updating timing and frequency pre-compensation will be illustrated through different embodiments.

In some embodiments, the information of updating timing and frequency pre-compensation may include one or more compensation segments. The compensation segment may be used to indicate the timing, time interval, or duration of a time period of one or more timing and frequency pre-compensation updates. For example, the one or more compensation segments may include a first compensation segment, which may indicate the duration of the time period or time interval of one or more pre-compensation updates that result in the failure in power consistency and phase continuity. For example, the first compensation segment may indicate the duration of the time period of the current timing and frequency pre-compensation update or the time interval since the last timing and frequency pre-compensation update. Alternatively, the first compensation segment may indicate the duration of the time period or interval of multiple timing and frequency pre-compensation updates within the first time period. It is understandable that the one or more compensation segments may reflect information about the DMRS bundling window length used by the terminal device during each transmission.

In some cases, the compensation segment may be a predefined value. Alternatively, the compensation segment may be a fixed value. In some cases, the compensation segment may be a dynamically changing value. In some cases, the compensation segment may be determined based on the first event. Herein, the first event may be related to the failure in power consistency and/or phase continuity. For example, in a scene insensitive to delay, after a period of continuous transmission by the terminal device, information of the DMRS bundling window length corresponding to the period may already be known. Based on the above, the terminal device may report the determined compensation segment to the network device, and upon receiving the compensation segment, the network device may demodulate the received information about the transmission process. For example, in cases where the Doppler shift changes frequently, the information of the DMRS bundling window length also changes correspondingly frequently. Based on the above, the terminal device may dynamically report the compensation segment to the network device.

The following is an example where the first compensation segment is used to indicate multiple time periods for timing and frequency pre-compensation update. The first information indicates that a time period for timing and frequency pre-compensation update is 11 slots in a current and subsequent time period. The configured nominal time domain window length is 32 slots, and the first event occurs at the end of slot 15. In such cases, the DMRS bundling window length should be as follows: a first segment: from the start instant of slot 0 to the end instant of slot 10, lasting for 11 slots; a second segment: from the start instant of slot 11 to the end instant of slot 15, lasting for 5 slots; a third segment: from the start instant of slot 16 to the end instant of slot 21, lasting for 6 slots; a fourth segment: from the start instant of slot 22 to the end instant of slot 31, lasting for 10 slots. The first segment is determined to be 11 slots based on the indication of the first compensation segment. The second segment ends at slot 15 based on time of occurrence of the first event. Since the second segment is 5 slots and there are 6 slots remaining to reach the time period for timing and frequency pre-compensation indicated by the first compensation segment, the third segment may be determined to be 6 slots. The fourth segment ends due to the completion of the nominal time domain window length.

In some implementations, when the timing and frequency pre-compensation information includes a plurality of compensation segments, the plurality of compensation segments may respectively indicate the corresponding time periods of the timing and frequency pre-compensation update, i.e., the plurality of compensation segments correspond one-to-one to the time periods of multiple pre-compensation updates that result in the failure in power consistency and phase continuity. It is understandable that the plurality of compensation segments may reflect the DMRS bundling window length information used by the terminal device during each transmission.

In some embodiments, the information of updating timing and frequency pre-compensation may include one or more compensation segments, and a quantity of repetitions associated with or corresponding to the compensation segments. Taking the case where the one or more compensation segments include the first compensation segment as an example, based on the associated quantity of repetitions, the first compensation segment may be repeatedly valid or continue for the corresponding quantity of repetitions. The following provides an example for description.

The compensation segment included in the information of updating timing and frequency pre-compensation may be 11 slots or 10 slots. The quantity of repetitions corresponding to 11 slots may be 2, and the quantity of repetitions corresponding to 10 slots may be 1. If the configured nominal time domain window length is 32 slots, and the first event occurs at the end of slot 15, then the DMRS bundling window length may be determined as follows: a first segment: from the start instant of slot 0 to the end instant of slot 10, lasting for 11 slots; a second segment: from the start instant of slot 11 to the end instant of slot 15, lasting for 5 slots; a third segment: from the start instant of slot 16 to the end instant of slot 21, lasting for 6 slots; a fourth segment: from the start instant of slot 22 to the end instant of slot 31, lasting for 10 slots. The first segment is determined based on the compensation segment having the first repetition of 11 slots. The second segment ends at slot 15 based on the first event. The third segment is determined based on the compensation segment having the second repetition of 11 slots. The fourth segment is determined based on the compensation segment having the one-time repetition of 10 slots.

In some embodiments, the information of updating timing and frequency pre-compensation may include a first compensation segment and one or more adjustment amounts. The first compensation segment may be configured to indicate a time period for timing and frequency pre-compensation update. A second compensation segment may be configured to indicate another time period for updating timing and frequency pre-compensation. The second compensation segment may be determined based on the first compensation segment and the one or more adjustment amounts. Therefore, in some embodiments, the first compensation segment may also be referred to as an initial compensation segment.

It should be noted that the reporting accuracy of one or more compensation segments and adjustment amounts may be relatively high in the case of determining the time period of the pre-compensation update in combination with the adjustment amounts. The reporting accuracy may be, for example, one or more decimal places. However, the pre-compensation update actually occurs between slots. Therefore, when the unit of the compensation segment is slot, rounding may be applied to one or more compensation segments to ensure that the amount of time compensation segment of the pre-compensation update is an integer multiple of a slot. Rounding may be achieved by rounding down. For example, the first compensation segment may be 10.5 slots, and the time period of the pre-compensation update that results in the failure in power consistency and phase continuity indicated by the first compensation segment may be 10 slots.

As an implementation, the second compensation segment may be determined based on the first compensation segment and a first adjustment amount. The second compensation segment may satisfy the following: x₀+x₁*t. Herein, x₀ may represent the first compensation segment, x₁ may represent the first adjustment amount, and t may represent a time difference between a start instant of the first compensation segment and an instant within the second compensation segment. Alternatively, t may represent a difference between any instant after the start instant of the first compensation segment (denoted as a first instant) and the start instant of the first compensation segment. The second compensation segment may be a compensation segment that includes the first instant. In some cases, the first instant may be the current instant, i.e., the second compensation segment may be the current time period for timing and frequency pre-compensation update. The following provides a specific example for description.

Assume that the first compensation segment is 10.50, the first adjustment amount is −0.02, the configured nominal time domain window length is 32 slots, and the first event occurs at the end of slot 15. After

$$\frac{10.5 - 10}{0.02} = 25 slots ,$$

the DMKS bundling window length is adjusted to less than 10 slots (i.e., 9 slots). Based on the above, the DMRS bundling window length should be as follows: a first segment: from slot 0 to slot 9, lasting for 10 slots; a second segment: from slot 10 to slot 15, lasting for 6 slots; a third segment: from slot 16 to slot 19, lasting for 4 slots; a fourth segment: from slot 20 to slot 28, lasting for 9 slots; a fifth segment: from slot 29 to slot 31. It can be seen that the first segment, the second segment, and the third segment are all within slots 0 to 24, and therefore the window length may be determined based on 10 slots. The fourth segment includes slot 25, i.e., the DMRS bundling window length is adjusted to 9 slots. Therefore, the fourth segment lasts for 9 slots. The second compensation segment may be used to indicate any one of the first segment to the fifth segment.

The method for determining the first compensation segment and/or the first adjustment amount is not limited in the present disclosure. For example, the first compensation segment and/or the first adjustment amount may be determined based on changes in transmission delay and Doppler shift. As an implementation, the first adjustment amount may be determined based on one or more of the following information: trajectory, movement speed, and movement direction of a satellite, as well as location of the terminal device. For example, based on the trajectory of a satellite, it may be determined that the satellite is moving away from the terminal device at a specific speed during a certain transmission process. In such cases, it may be determined that the transmission delay increases at a specific rate during the continuous transmission. Accordingly, the phase difference between DMRS symbols during the DMRS bundling process changes more rapidly with time, making it necessary for the terminal device to correspondingly shorten the timing and frequency pre-compensation update time period. Therefore, the first adjustment amount may be set to a value capable of shortening the timing and frequency pre-compensation update time period. For example, the first adjustment amount may be positive or negative. A positive first adjustment amount may indicate that the timing and frequency pre-compensation update time period gradually lengthens. A negative first adjustment amount may indicate that the timing and frequency pre-compensation update time period gradually shortens.

As an implementation, the second compensation segment may be determined based on the first compensation segment, the first adjustment amount, and a second adjustment amount. For example, the second compensation segment may satisfy the following: x₀−x₁*t−x₂*t₂. Herein, x₀ may represent the first compensation segment, x₁ may represent the first adjustment amount, x₂ may represent the second adjustment amount, and t may represent a time difference between a start instant of the first compensation segment and an instant corresponding to the second compensation segment. Herein, the instant corresponding to the second compensation segment may be any instant during the duration of the second compensation segment. Alternatively, t may represent a difference between any instant after the start instant of the first compensation segment (denoted as a first instant) and the start instant of the first compensation segment. The second compensation segment may be a compensation segment that includes the first instant. In some cases, the first instant may be the current instant, i.e., the second compensation segment may be the current time period for timing and frequency pre-compensation update. The following provides a specific example for description.

Assume that the first compensation segment is 10.30, the first adjustment amount is −0.02, the second adjustment amount is −0.001, and the configured nominal TDW is 32 slots. After 10 slots, the time period for timing and frequency pre-compensation update is 10.30−0.02*10−0.001*10²=10. Since the time period for timing and frequency pre-compensation update continues to decrease, after 10 slots, the time period for timing and frequency pre-compensation update will be 9 slots. After 10 slots, the time period for timing and frequency pre-compensation update should change by 0.02*9+0.001*81=0.261 every 9 slots. That is, after 35 slots, the time period for timing and frequency pre-compensation update decreases to less than 9 slots. Therefore, assuming that no other events occur, the DMRS bundling window length may be as follows: a first segment: from slot 0 to slot 9, lasting for 10 slots; a second segment: from slot 10 to slot 18, lasting for 9 slots; a third segment: from slot 19 to slot 28, lasting for 10 slots; a fourth segment: from slot 29 to slot 31; a fifth segment: from slot 32 to slot 40, lasting for 9 slots; a sixth segment: from slot 41 to slot 47, lasting for 7 slots; and so on. The second compensation segment may be used to indicate one or more of the second segment to the sixth segment.

The method for determining the first compensation segment, the first adjustment amount, or the second adjustment amount is not limited in the present disclosure. As an implementation, the first adjustment amount and the second adjustment amount may be determined based on one or more of the following information: trajectory, movement speed, and movement direction of a satellite, as well as location of the terminal device. For example, based on the trajectory of a satellite, it may be determined that the satellite is moving away from the terminal device at a specific speed during a certain transmission process. In such cases, it may be determined that the transmission delay increases at a specific rate during the continuous transmission. Additionally, if the speed of tangential motion of the satellite relative to the terminal device increases at a specific rate during a certain transmission process, the Doppler shift increases at a specific rate, causing the transmission delay to change more rapidly with time. Accordingly, the phase difference between DMRS symbols during the DMRS bundling process changes more rapidly with time, making it necessary for the terminal device to correspondingly shorten the DMRS bundling window length. For example, the precise current timing and frequency pre-compensation update time period (and thus the first compensation segment), the first adjustment amount, and the second adjustment amount may be determined based on changes in transmission delay and Doppler shift.

It should be noted that the adjustment amount may be positive or negative. In some embodiments, the adjustment amount may also be referred to as an adjustment increment. When the adjustment increment is positive, the second compensation segment may be longer than the first compensation segment; when the adjustment increment is negative, the second compensation segment may be shorter than the first compensation segment.

In some embodiments, the information of updating timing and frequency pre-compensation may be related to the phase difference between DMRS symbols. That is, the terminal device may determine the information of updating timing and frequency pre-compensation based on the phase difference between DMRS symbols. The present disclosure proposes that the phase difference between DMRS symbols may be determined based on delay drift or Doppler shift. For example, when a satellite orbits the earth at a constant speed on a 1200 km altitude trajectory, the variation in relative location caused by the low-speed movement of the terminal device is negligible compared to a fast-moving satellite. Based on the above, the changes in delay drift and Doppler shift caused by satellite motion may be calculated based on the location, movement direction, and movement speed of the satellite. The phase difference ΔØ between DMRS symbols may satisfy the following equation: ΔØ=ΔT_{drift}×Fₛ×360°. Herein, ΔT_{drift} is the delay drift, and Fₛ is half of the transmission bandwidth. The phase difference ΔØ between DMRS symbols may satisfy the following equation: ΔØ=2π*f_{Doppler}*t, where t represents the duration corresponding to the phase difference, f_{Doppler} represents the amount of change in Doppler shift, f_{Doppler} satisfies Δf_{Doppler}*t, and Δf_{Doppler} represents the rate of change in Doppler shift.

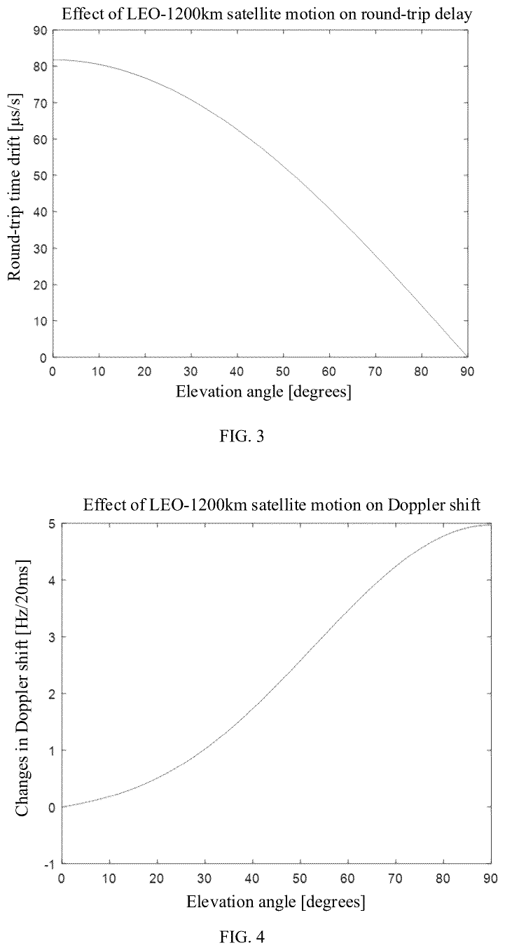

FIG. 3 shows the effect of satellite motion on round-trip delay. FIG. 4 shows the effect of satellite motion on Doppler shift. When the satellite is at an elevation angle of 30 degrees to the ground, as shown in FIG. 3, the delay drift caused by satellite motion is 71 ns/ms. Assuming a transmission bandwidth of 360 kHz, the phase difference between DMRS symbols per slot may be ΔØ=0.071 μs*180*10³*360=4.601 degrees. As shown in FIG. 4, the rate of change in Doppler shift caused by satellite motion is 0.256 Hz/ms, the phase difference between DMRS symbols versus time t is represented as ΔØ=2π×256×t², and the phase shift after 6 slots is ΔØ=0.058 degrees. Considering a phase offset limit of 30 degrees for DMRS symbols, the terminal device may determine that a timing and frequency pre-compensation update should be performed every 6 ms under the current state of satellite motion. Moreover, based on the satellite ephemeris, the terminal device can predict the future motion state of the satellite, and thus may predict the exact interval and variation required for its own timing and frequency pre-compensation update.

It should be noted that FIG. 3 and FIG. 4 are simulated under the assumption that the satellite is at the same elevation angle relative to the terminal device and the gateway.

It should be noted that the method for determining the first information is not limited in the present disclosure. The method for determining the first adjustment amount or the second adjustment amount in the first information is described above by embodiments. However, the determination of the first information is not limited to the method described above. For example, the first information may be determined based on one or more of the following information: ephemeris information corresponding to the network device, parameters configured by the network device, relative motion relationship between the terminal device and the network device, elevation angle of the network device (e.g., elevation angle of a satellite), and location information of the terminal device. Herein, the network device may be a satellite in NTN systems. The ephemeris information of a satellite may be used to determine changes in the satellite. For example, based on the ephemeris information, pre-determined information such as the trajectory, movement speed, and movement direction of the satellite can be obtained. The movement of the satellite during the continuous transmission of DMRS bundling can be obtained based on the trajectory of the satellite, thereby determining the effect of the movement on changes in delay, time drift, and Doppler shift, as well as the effect of these changes on the phase continuity of DMRS symbols. The terminal device can then predict the information (e.g., interval) of a pre-compensation update that results in the failure in power consistency and phase continuity based on the information described above, thereby determining the first information. For example, based on the trajectory of the satellite, the terminal device can determine that the satellite maintains an approximately constant speed and constant distance from the earth within a specific elevation angle range. In such cases, the changes in delay and Doppler shift remain stable, allowing the terminal device to predict how often a pre-compensation update that results in the failure in power consistency and phase continuity should be performed.

It should be noted that the transmission mode and/or format of the first information are not limited in the present disclosure. That is, the terminal device may transmit the first information to the network device in an appropriate format and/or mode.

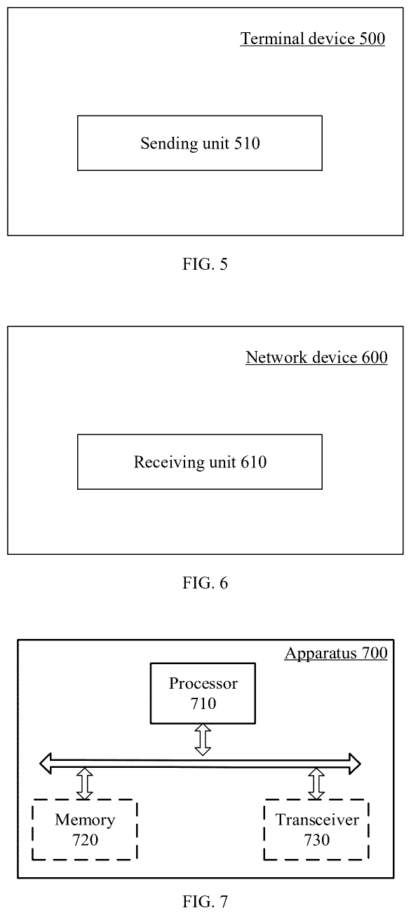

The method embodiments of the present disclosure are described in detail above. The apparatus embodiments of the present disclosure will be described in detail with reference to FIG. 5 to FIG. 7. It should be understood that the description of the method embodiments corresponds to the description of the apparatus embodiments, and therefore, for parts that are not described in detail, reference may be made to the foregoing method embodiments.

FIG. 5 is a schematic structural diagram of a terminal device 500 according to an embodiment of the present disclosure. The terminal device 500 may include a sending unit 510.

The sending unit 510 is configured to send first information to a network device, where the first information is configured to indicate information of updating timing and frequency pre-compensation within a first time period.

In some embodiments, the information of updating timing and frequency pre-compensation includes one or more compensation segments, which indicate a time period for updating pre-compensation in time domain and/or frequency domain.

In some embodiments, the compensation segment satisfies: the compensation segment is a predefined value; the compensation segment is a dynamically changing value; or the compensation segment is determined based on a first event, wherein the first event is associated with a failure in power consistency and/or phase continuity.

In some embodiments, the information of updating timing and frequency pre-compensation further includes: one or more compensation segments, which indicate a time period for updating pre-compensation in time domain and/or frequency domain; and a quantity of repetitions corresponding to the compensation segments.

In some embodiments, the information of updating timing and frequency pre-compensation includes a first compensation segment and a first adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment and the first adjustment amount.

In some embodiments, the information of updating timing and frequency pre-compensation includes a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment, the first adjustment amount, and the second adjustment amount.

In some embodiments, the second compensation segment satisfies the following: x₀−x₁*t−x₂*t₂, wherein x₀ represents the first compensation segment, x₁ represents the first adjustment amount, x₂ represents the second adjustment amount, and t is a time difference between a start instant of a first interval and a corresponding instant of a second interval.

In some embodiments, the first information is determined based on one or more of the following information: ephemeris information corresponding to the network device, parameters configured by the network device, relative motion relationship between the terminal device and the network device, elevation angle of the network device, and location information of the terminal device.

In some embodiments, the first information is used to determine a length of a first DMRS bundling window.

In some embodiments, the first DMRS bundling window belongs to a plurality of DMRS bundling windows, and the first information is used to determine lengths of the plurality of DMRS bundling windows.

In some embodiments, the length of the first DMRS bundling window is determined based on the first information and a nominal time domain window length.

In some embodiments, the first time period includes a current instant and/or a subsequent time period.

FIG. 6 is a schematic structural diagram of a network device 600 according to an embodiment of the present disclosure. The network device 600 may include a receiving unit 610.

The receiving unit 610 is configured to receive first information from a terminal device, where the first information indicates information of updating timing and frequency pre-compensation within a first time period.

In some embodiments, the information of updating timing and frequency pre-compensation includes one or more compensation segments, which indicate a time period for updating pre-compensation in time domain and/or frequency domain.

In some embodiments, the compensation segment satisfies: the compensation segment is a predefined value; the compensation segment is a dynamically changing value; or the compensation segment is determined based on a first event, wherein the first event is associated with a failure in power consistency and/or phase continuity.

In some embodiments, the information of updating timing and frequency pre-compensation further includes: one or more compensation segments, which indicate a time period for updating pre-compensation in time domain and/or frequency domain; and a quantity of repetitions corresponding to the compensation segments.

In some embodiments, the information of updating timing and frequency pre-compensation includes a first compensation segment and a first adjustment amount, the first compensation segment indicates a time period for updating pre-compensation in time domain and/or frequency domain, and a second compensation segment indicates another time period for updating pre-compensation in the time domain and/or frequency domain, the second compensation segment being determined based on the first compensation segment and the first adjustment amount.

In some embodiments, the information of updating timing and frequency pre-compensation includes a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment being determined based on the first compensation segment, the first adjustment amount, and the second adjustment amount.

In some embodiments, the second compensation segment satisfies the following: x₀−x₁*t−x₂*t₂, wherein x₀ represents the first compensation segment, x₁ represents the first adjustment amount, x₂ represents the second adjustment amount, and t is a time difference between a start instant of a first interval and a corresponding instant of a second interval.

In some embodiments, the first information is determined based on one or more of the following information: ephemeris information corresponding to the network device, parameters configured by the network device, relative motion relationship between the terminal device and the network device, elevation angle of the network device, and location information of the terminal device.

In some embodiments, the first information is used to determine a length of a first DMRS bundling window.

In some embodiments, the first DMRS bundling window belongs to a plurality of DMRS bundling windows, and the first information is used to determine lengths of the plurality of DMRS bundling windows.

In some embodiments, the length of the first DMRS bundling window is determined based on the first information and a nominal time domain window length.

In some embodiments, the first time period includes a current instant and/or a subsequent time period. In an optional embodiment, the sending unit 510 or receiving unit 610 may be a transceiver 730. The terminal device 500 or the network device 600 may further include a processor 710 and a memory 720, as specifically shown in FIG. 7.

FIG. 7 is a schematic structural diagram of an apparatus for communication according to an embodiment of the present disclosure. The dashed lines in FIG. 7 indicate that the unit or module is optional. The apparatus 700 may be configured to implement the method described in the foregoing method embodiments. The apparatus 700 may be a chip, a terminal device, or a network device.

The apparatus 700 may include one or more processors 710. The processor 710 may support the apparatus 700 to implement the method described in the foregoing method embodiments. The processor 710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, etc. The general-purpose processor may be a microprocessor, or the processor may be any conventional processor, etc.

The apparatus 700 may further include one or more memories 720. The memory 720 stores a program that may be executed by the processor 710, causing the processor 710 to perform the method described in the foregoing method embodiments. The memory 720 may be independent of the processor 710 or may be integrated into the processor 710.

The apparatus 700 may further include a transceiver 730. The processor 710 may communicate with another device or chip through the transceiver 730. For example, the processor 710 may transmit data to and receive data from another device or chip through the transceiver 730.

An embodiment of the present disclosure further provides a computer-readable storage medium for storing a program. The computer-readable storage medium may be applied to the terminal or network device provided in embodiments of the present disclosure, and the program causes a computer to perform the method to be performed by the terminal or network device in various embodiments of the present disclosure.

An embodiment of the present disclosure further provides a computer program product. The computer program product includes a program. The computer program product may be applied to the terminal or network device provided in embodiments of the present disclosure, and the program causes a computer to perform the method to be performed by the terminal or network device in various embodiments of the present disclosure.

An embodiment of the present disclosure further provides a computer program. The computer program may be applied to the terminal or network device provided in embodiments of the present disclosure, and the computer program causes a computer to perform the method to be performed by the terminal or network device in various embodiments of the present disclosure.

It should be understood that the terms “system” and “network” may be used interchangeably in the present disclosure. In addition, the terms used in the present disclosure are only used to explain the specific embodiments of the present disclosure, and are not intended to limit the present disclosure. The terms “first”, “second”, “third”, “fourth”, and the like in the specification, claims, and accompanying drawings of the present disclosure are used to distinguish between different objects, rather than to describe a specific order. In addition, the terms “include” and “have”, as well as any variations thereof, are intended to cover a non-exclusive inclusion.

In embodiments of the present disclosure, “indication” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of the present disclosure, “B corresponding to A” means that B is associated with A and B may be determined based on A. However, it should also be understood that determining B based on A does not mean determining B only based on A, but instead B may be determined based on A and/or other information.

In embodiments of the present disclosure, the term “corresponding” may mean that there is a direct or indirect correspondence between two elements, or that there is an association relationship between two elements, or that there is a relationship such as indicating and being indicated, configuring and being configured, or the like.

In embodiments of the present disclosure, “pre-defining” or “pre-configuring” may be implemented by pre-storing a corresponding code, a table, or other forms that may be used to indicate related information in devices (for example, including a terminal device and a network device). The specific implementation is not limited in the present disclosure. For example, being predefined may refer to being defined in a protocol.

In embodiments of the present disclosure, the “protocol” may refer to a standard protocol in the field of communications, and may include, for example, an LTE protocol, an NR protocol, and a related protocol applied to a future communications system, which is not limited in the present disclosure.

In embodiments of the present disclosure, the term “and/or” is merely an association relationship that describes associated objects, indicating that there may be three relationships. For example, A and/or B may represent three cases: only A is present, both A and B are present, and only B is present. In addition, the character “/” herein generally indicates an “or” relationship between the associated objects.

In various embodiments of the present disclosure, sequence numbers of the aforementioned processes do not imply a sequence of execution. The execution order of each process should be determined based on its function and internal logic, and should not impose any limitation on the implementation process of the embodiments of the present disclosure.

In several embodiments provided in the present disclosure, it should be understood that, the disclosed system, apparatus, and method may be implemented in other ways. For example, the apparatus embodiments described above are merely illustrative. For example, the division of units is merely a logical functional division, and there may be other ways of division in actual implementation. For example, a plurality of units or components may be combined or integrated into another system, or some features may be omitted or not implemented. In addition, the displayed or discussed mutual couplings or direct couplings or communication connections may be implemented through via some interfaces, indirect coupling or communication connection between devices or units may be implemented in electronic, mechanical, or other forms.

The units described as separate components may or may not be physically separated, and the components displayed as units may or may not be physical units, i.e., they may be located in one place or distributed on a plurality of network units. Some or all of the units may be selected according to actual needs to achieve the purpose of the solutions of embodiments.

In addition, function units in various embodiments of the present disclosure may be integrated into one processing unit, or each of the units may exist alone physically, or two or more units may be integrated into one unit.

The foregoing embodiments may be implemented completely or partially by software, hardware, firmware, or any combination thereof. When implemented using software, the foregoing embodiments may be implemented completely or partially in a form of a computer program product. The computer program product includes one or more computer instructions. When the computer program instructions are loaded and executed on a computer, the procedures or functions according to the embodiments of the present disclosure are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (e.g., a coaxial cable, an optical fiber, and a digital subscriber line (DSL)) manner or a wireless (e.g., infrared, wireless, and microwave) manner. The computer-readable storage medium may be any available medium readable by a computer, or a data storage device, such as a server or a data center integrated with one or more available media. The available medium may be a magnetic medium (e.g., a floppy disk, a hard disk, or a magnetic tape), an optical medium (e.g., a digital video disc (DVD)), or a semiconductor medium (e.g., a solid-state drive (SSD)).

The foregoing descriptions are merely specific implementations of the present disclosure, but the scope of protection of the present disclosure is not limited thereto. Any changes or substitutions readily figured out by those skilled in the art within the technical scope disclosed in the present disclosure shall fall within the scope of protection of the present disclosure. Therefore, the scope of protection of the present disclosure shall be subject to the scope of protection of the appended claims.

What is claimed is:

1. A communication method, comprising:
sending, by a terminal device, first information to a network device in a non-terrestrial network (NTN) cell;
wherein the first information indicates information of updating timing and frequency pre-compensation within a first time period.

2. The method according to claim 1, wherein the information of updating timing and frequency pre-compensation comprises one or more compensation segments, the one or more compensation segments indicate a time period for updating pre-compensation in time domain and/or frequency domain.

3. The method according to claim 2, wherein the compensation segment is determined based on one or more of following:
a predefined value;
a dynamically changing value; or
a first event, wherein the first event is associated with a failure in power consistency and/or phase continuity.

4. The method according to claim 1, wherein the information of updating timing and frequency pre-compensation further comprises:
one or more compensation segments, wherein the one or more compensation segments indicate a time period for updating pre-compensation in time domain and/or frequency domain; and
a quantity of repetitions corresponding to the compensation segments.

5. The method according to claim 1, wherein the information of updating timing and frequency pre-compensation comprises a first compensation segment and a first adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment and the first adjustment amount.

6. The method according to claim 1, wherein the information of updating timing and frequency pre-compensation comprises a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment, the first adjustment amount, and the second adjustment amount.

7. The method according to claim 6, wherein the second compensation segment satisfies following: x₀−x₁*t−x₂*t₂, wherein x₀ represents the first compensation segment, x₁ represents the first adjustment amount, x₂ represents the second adjustment amount, and t is a time difference between a start instant of a first interval and a corresponding instant of a second interval.

8. The method according to claim 1, wherein the first information is determined based on one or more of following information: ephemeris information corresponding to the network device, parameters configured by the network device, relative motion relationship between the terminal device and the network device, elevation angle of the network device, and location information of the terminal device.

9. The method according to claim 1, wherein the first information is used to determine a length of a first demodulation reference signal (DMRS) bundling window.

10. The method according to claim 9, wherein the first DMRS bundling window belongs to a plurality of DMRS bundling windows, and the first information is used to determine lengths of the plurality of DMRS bundling windows.

11. The method according to claim 9, wherein the length of the first DMRS bundling window is determined based on the first information and a nominal time domain window length.

12. The method according to claim 1, wherein the first time period comprises a current instant and/or a subsequent time period.

13. A communication method, comprising:
receiving, by a network device, first information from a terminal device in an NTN cell;
wherein the first information indicates information of updating timing and frequency pre-compensation within a first time period.

14. The method according to claim 13, wherein the information of updating timing and frequency pre-compensation comprises one or more compensation segments, the one or more compensation segments indicate a time period for updating pre-compensation in time domain and/or frequency domain.

15. The method according to claim 14, wherein the compensation segment is determined based on one or more of following:
a predefined value;
a dynamically changing value; or
a first event, wherein the first event is associated with a failure in power consistency and/or phase continuity.

16. The method according to claim 13, wherein the information of updating timing and frequency pre-compensation further comprises:
one or more compensation segments, wherein the one or more compensation segments indicate a time period for updating pre-compensation in time domain and/or frequency domain; and
a quantity of repetitions corresponding to the compensation segments.

17. The method according to claim 13, wherein the information of updating timing and frequency pre-compensation comprises a first compensation segment and a first adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment and the first adjustment amount.

18. The method according to claim 13, wherein the information of updating timing and frequency pre-compensation comprises a first compensation segment, a first adjustment amount, and a second adjustment amount, the first compensation segment indicates a time period for updating pre-compensation in time domain and/or frequency domain, a second compensation segment indicates another time period for updating pre-compensation in time domain and/or frequency domain, and the second compensation segment is determined based on the first compensation segment, the first adjustment amount, and the second adjustment amount.

19. The method according to claim 18, wherein the second compensation segment satisfies following: x₀−x₁*t−x₂*t₂, wherein x₀ represents the first compensation segment, x₁ represents the first adjustment amount, x₂ represents the second adjustment amount, and t is a time difference between a start instant of a first interval and a corresponding instant of a second interval.

20. A terminal device, comprising:
a memory and a processor, wherein the memory is configured to store a program, and the processor is configured to invoke the program in the memory to perform:
sending first information to a network device in an NTN cell;
wherein the first information is configured to indicate information of updating timing and frequency pre-compensation within a first time period.
